(19) United States
(12) Patent Application Publication
(10) Pub. No.: US 2025/0284017 A1
(43) Pub. Date: Sep. 11, 2025

(54) SOFTWARE-DEFINED HYDROPHONE WITH ACOUSTIC SENSOR FUNCTIONS AND MACHINE LEARNING

(71) Applicant: BLUEiQ LLC, Harvard, MA (US)

(72) Inventors: Robert Joseph McGurrin, Arlington, MA (US); Kimberly E. Gavin, Harvard, MA (US)

(73) Assignee: BLUEiQ LLC, Harvard, MA (US)

(21) Appl. No.: 19/216,460

(22) Filed: May 22, 2025

Related U.S. Application Data
(63) Continuation-in-part of application No. 18/743,598, filed on Jun. 14, 2024.
(60) Provisional application No. 63/521,361, filed on Jun. 16, 2023.
(60) Provisional application No. 63/573,161, filed on Apr. 2, 2024.
(60) Provisional application No. 63/651,786, filed on May 24, 2024.
(60) Provisional application No. 63/658,937, filed on Jun. 12, 2024.

(51) Int. Cl. G01V 1/38; G01V 1/18

(52) U.S. Cl. CPC G01V 1/3808; G01V 1/186; G01V 1/3843; G01V 2210/1423

(57) ABSTRACT

Disclosed techniques enable improved analysis of acoustic data. An acoustic sensor that includes one or more acoustic channels is accessed. The acoustic sensor is coupled to one or more hydrophones. A first hydrophone is associated with a first acoustic channel within acoustic channels. The acoustic sensor and the hydrophones are deployed in a body of water. One or more digital signal processing (DSP) functions of the acoustic sensor are programmed via software. A first DSP function is associated with a first frequency band and the first acoustic channel. A first underwater audio signal is received by the first hydrophone. The first underwater audio signal is analyzed by the acoustic sensor which includes sampling the first underwater audio signal. The analyzing is based on the first DSP function associated with the first acoustic channel.

### RELATED APPLICATIONS

This application claims the benefit of U.S. provisional patent application “Software-Defined Acoustic Sensor Functions With Machine Learning” Ser. No. 63/651,786, filed May 24, 2024.

This application is also a continuation-in-part of U.S. patent application “Automated Passive Acoustic Monitoring With Machine Learning” Ser. No. 18/743,598, filed Jun. 14, 2024, which claims the benefit of U.S. provisional patent applications “Automated Passive Acoustic Monitoring With Machine Learning” Ser. No. 63/521,361, filed Jun. 16, 2023, “Hydrophone Data Over Internet Protocol With Machine Learning” Ser. No. 63/573, 161, filed Apr. 2, 2024, “Software-Defined Acoustic Sensor Functions With Machine Learning” Ser. No. 63/651,786, filed May 24, 2024, and “Self-Arranging Acoustic Glider Array With Machine Learning” Ser. No. 63/658,937, filed Jun. 12, 2024.

Each of the foregoing applications is hereby incorporated by reference in its entirety.

### FIELD OF ART

This application relates generally to manipulating acoustic data and more particularly to a software-defined hydrophone with acoustic sensor functions and machine learning.

### BACKGROUND

From ancient times, humans have been fascinated by bodies of water. The larger the body of water is, the more mysteries it holds for us to explore. Some study the makeup of the water itself. The physical, chemical, and biological features of the ocean have been investigated by individuals and groups for many hundreds of years. Physical characteristics of ocean water include temperature, salinity, density, ocean currents, waves, tides, light, and sound. Variations in these characteristics can be wide-ranging and complex. Animal and plant life thrive in many levels of ocean depths, and human interactions with ocean characteristics can and does impact the lives of many organisms across the globe. Marine ecosystems stretch across vast sections of ocean in three dimensions, with differing species existing from the surface to many miles in depth. The distribution and adaptations of marine plants, animals, and microbes can change drastically from one local oceanic zone to another. Fisheries and conservation organizations can sometimes work together, and at other times at odds with one another, as they try to determine the current and future outlooks for species of ocean organisms.

Chemical fluctuations across various regions based on human causes and natural processes are examined by colleges and universities, as well as corporate and national organizations. Seawater contains a variety of salts, gases, and organic matter which interact with one another in various ways. The local chemical makeup of ocean water can vary significantly from one region to another. Photoelectric effects from sunlight, along with wind and storm patterns, can impact the upper regions of seawater in many ways as well. As weather patterns shift due to global warming trends and continued human activity, the makeup of seawater and the consequences of these changes on life on earth continue to be studied. Ocean temperatures affect more than weather patterns; they impact the lives of many marine species, which in turn affects many land-based species all over the world. Ocean current flow and circulation patterns also influence marine plant and animal life which can have far-reaching effects on oxygenation, food sources, and sustainability.

The vast majority of water on the Earth is saltwater, comprising approximately 97% of all water on the planet. Much of the freshwater that exists is in the form of ice in glaciers and polar ice caps. Most of the rest of freshwater exists as groundwater. Less than 1% of all fresh water is readily accessible to humans in lakes, rivers, streams, and so on. Thus, desalination efforts can be an important part of human and other land-based species' continued survival as we work to create more usable land for crops, as well as water for drinking and industrial concerns. Reverse osmosis, electrodialysis, flash distillation, and vapor compression methods continue to be studied and improved as we work to tap the vast stretches of seawater for use by humans.

Ocean current and wave patterns and their effects on weather are studied from airplanes, ships, and satellites. Data flows into complex computer simulations to predict the directions of storms and the long-term effects of global warming. Energy flow into and out of bodies of water can help us to understand how to tap solar and geothermal energy for use by cities and towns. Oceanic studies are conducted using surface and underwater vessels, airplanes, satellites, and spacecraft. Because these bodies of water cover seventy percent of the planet's surface, paying attention to what is happening around, and even under our oceans will continue to be important to all life on planet Earth.

### SUMMARY

Underwater monitoring of audio signals has been used for understanding marine life, tracking surface and underwater vessels, observing geological events, and expanding our knowledge of the ocean environment. Underwater audio signals can be analyzed by passive acoustic monitoring (PAM), using underwater microphones to collect sound data. These signals can be processed, and sources of the audio signals can be identified. Once collected, these signals can be processed to accomplish a number of purposes including location tracking, vessel detection, activity monitoring, and so on.

A processor-implemented method for manipulating acoustic data is disclosed. An acoustic sensor that includes one or more acoustic channels is accessed. The acoustic sensor is coupled to one or more hydrophones. A first hydrophone is associated with a first acoustic channel within acoustic channels. The acoustic sensor and the hydrophones are deployed in a body of water. One or more digital signal processing (DSP) functions of the acoustic sensor are programmed via software. A first DSP function is associated with a first frequency band and the first acoustic channel. A first underwater audio signal is received by the first hydrophone. The first underwater audio signal is analyzed by the acoustic sensor which includes sampling the first underwater audio signal. The analyzing is based on the first DSP function associated with the first acoustic channel.

A processor-implemented method for manipulating acoustic data is disclosed comprising: accessing an acoustic sensor, wherein the acoustic sensor includes one or more acoustic channels, wherein the acoustic sensor is coupled to one or more hydrophones, and wherein a first hydrophone within the one or more hydrophones is associated with a first acoustic channel within the one or more acoustic channels; deploying, in a body of water, the acoustic sensor and the one or more hydrophones; programming, via software, one or more digital signal processing (DSP) functions of the acoustic sensor, wherein a first DSP function is associated with a first frequency band and the first acoustic channel; receiving, by the first hydrophone, a first underwater audio signal; and analyzing, by the acoustic sensor, the first underwater audio signal, wherein the analyzing includes sampling the first underwater audio signal, and wherein the analyzing is based on the first DSP function associated with the first acoustic channel.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a software-defined hydrophone with acoustic sensor functions and machine learning.

FIG. 2 is a flow diagram for programming DSP functions.

FIG. 3 is an infographic for automated passive acoustic monitoring.

FIG. 4 is an infographic for a software-defined hydrophone with acoustic sensor functions.

FIG. 5 is a block diagram of an embedded controller.

FIG. 6 is a diagram of an acoustic sensor with hydrophones.

FIG. 7 is an example of a convolutional neural network.

FIG. 8 is a system diagram for a software-defined hydrophone with acoustic sensor functions and machine learning.

### DETAILED DESCRIPTION

Exploring of the oceans has long been a fascination of mankind. Advancements in technology, such as unmanned underwater vehicles (UUVs), remotely operated vehicles (ROVs), sonar, and eDNA sampling have increased our understanding of marine life and the impact of human activity on the underwater world. Passive acoustic monitoring (PAM) technology has been particularly useful for detecting and monitoring underwater activity such as vehicle operation, human activity, marine life activity, and so on. Analyzing underwater sound waves such as these can play a critical role in protecting marine life, understanding marine ecosystems, detecting suspicious human activities such as illegal fishing, mitigating risks to mission-critical oceanic equipment, and so on. However, these audio signals can be challenging to analyze. While water readily transmits sound, the larger the body of water, the more sounds occur and overlap. For example, marine species can produce sounds across a wide frequency range which can overlap with human activities or SONAR systems. In addition, underwater sound properties can change depending on depth and water temperature. These factors make generating accurate analysis, including the separation and identification of underwater audio sources, a daunting task requiring significant computing resources. Often, multiple systems are required, each tuned to monitor a specific frequency range. As a result, a comprehensive PAM system can require multiple application-specific devices, driving costs and limiting scalability. Further, it is often desired to deploy PAM systems in remote locations which can have limited access to power. This can be problematic for the processing equipment needed to analyze audio signals, especially when multiple systems are required.

To address the issues commonly experienced with PAM systems, a software-defined hydrophone with acoustic sensor functions and machine learning is disclosed. An acoustic sensor is accessed. The acoustic sensor includes one or more acoustic channels and is coupled to one or more hydrophones. The acoustic sensor and the one or more hydrophones can comprise a software-defined hydrophone (SDH). A first hydrophone is associated with a first acoustic channel. The acoustic sensor and the hydrophones are deployed in a body of water. One or more digital signal processing (DSP) functions of the acoustic sensor are programmed via software. A first DSP function is associated with a first frequency band and the first acoustic channel. The programming can be accomplished remotely. A first underwater audio signal is received by the first hydrophone. The acoustic sensor can filter the first underwater audio signal. The filtering can be based on the first frequency band. The acoustic sensor analyzes the first underwater audio signal, based on the first DSP function associated with the first acoustic channel. The analyzing includes sampling the first underwater audio signal.

The first DSP function can include recording data, tracking a fish tag, detecting a vessel, monitoring an underwater object of interest, signal intelligence, and so on. The embedded acoustic controller can host a machine learning model. The first DSP function can include classifying an underwater signal source. The programming can include a second DSP function associated with a second frequency band and a second acoustic channel. A second hydrophone can be associated with the second acoustic channel. The second hydrophone can receive a second underwater audio signal which can be filtered by the acoustic sensor based on the second frequency band. The second underwater audio signal can be evaluated by the acoustic sensor, based on the second DSP function associated with the second acoustic channel. The analyzing of the first underwater audio signal and the evaluating of the second underwater audio signal can occur in parallel. The acoustic sensor can be reprogrammed.

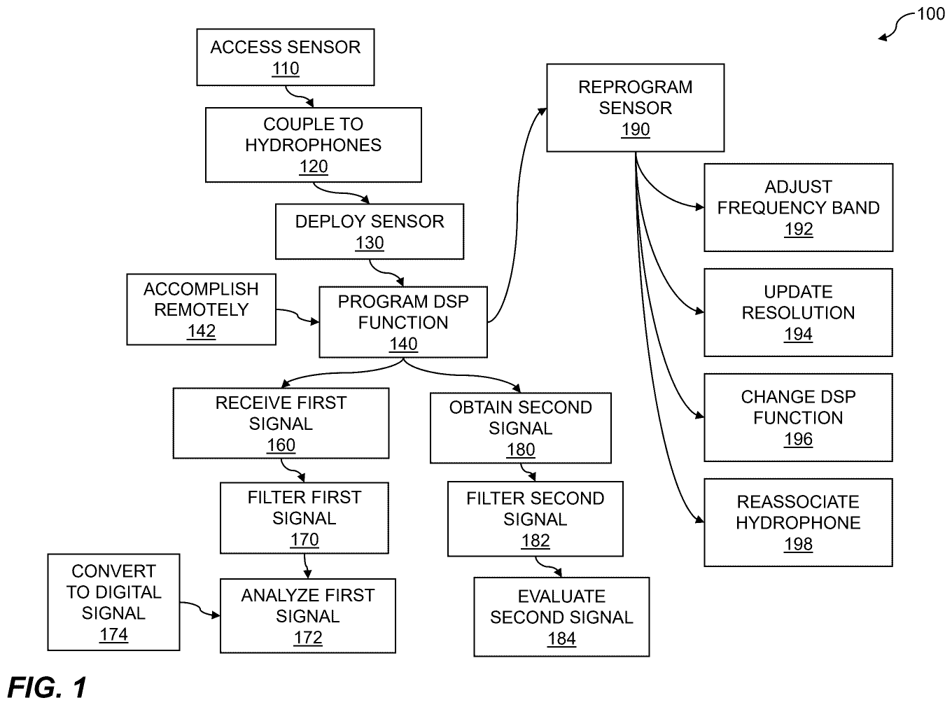

FIG. 1 is a flow diagram 100 for a software-defined hydrophone with acoustic sensor functions and machine learning. The software-defined hydrophone (SDH) can enable a dynamically configurable PAM system. The flow 100 includes accessing a sensor 110. Embodiments include accessing an acoustic sensor, wherein the acoustic sensor includes one or more acoustic channels, wherein the acoustic sensor is coupled to one or more hydrophones, and wherein a first hydrophone within the one or more hydrophones is associated with a first acoustic channel within the one or more acoustic channels. An acoustic sensor is a device designed to detect, measure, analyze, etc. sound waves or acoustic signals in an underwater environment. The acoustic sensor can include any number of embedded acoustic controllers, embedded processors, acoustic controllers, digital down converters, filters, processors, memory devices, storage devices, neural processors, I/O devices and ports such as Ethernet, wireless communications devices such as Bluetooth, Zigby, etc., broadband communications devices such as 5G, satellite communications, power supplies, batteries, and so on. The sensor can include capabilities for running machine learning (ML) models, such as small language models (SLMs), neural networks, convolutional neural networks (CNNs), and so on. The machine learning models can be implemented as a TinyML™ model on a resource constrained resource such as an embedded processor or acoustic embedded controller. The machine learning models can comprise edge artificial intelligence (AI). The sensor can include a watertight enclosure to protect electronics, such as those mentioned above. The watertight enclosure can be made of metal, plastic, another material, or a combination of materials. Watertight plugs for connecting one or more hydrophones to the sensor can be included in the watertight enclosure.

The acoustic sensor includes one or more acoustic channels. Any number of acoustic channels can be supported. The channels can allow the sensor to receive signals for processing. The acoustic channels can be programmable via software such that each channel can be assigned a frequency, bandwidth, filter, machine learning function, digital signal processing (DSP) function, etc. The sensor can support multiple channels operating independently for signal processing on more than acoustic signal, frequency, bandwidth, etc.

The flow 100 includes coupling the acoustic sensor to one or more hydrophones 120. A hydrophone is a microphone that can detect sounds underwater. It can be used to record or monitor marine organisms, submarines, ships, and other underwater activities that generate sound. A hydrophone can convert the sound waves into electrical signals and send them to an embedded acoustic controller, processor, etc. for analysis via digital signal processing (DSP), machine learning, and so on. Other sensors can be coupled to the acoustic sensor such as modular transducers and pre-amplifiers. The hydrophones and/or other sensors can be coupled to the sensor via the acoustic channels, which can be changed at any time via software. Any number of hydrophones can be coupled to any audio channel, allowing for support of various acoustic monitoring configurations. The hydrophones can include a pre-amplifier which can enable detection and analysis of audio sounds by the acoustic sensor. The hydrophone can be associated with a frequency band, such as 10 Hz to 1 MHz, or another suitable frequency band. A first hydrophone within the one or more hydrophones is associated with a first acoustic channel within the one or more acoustic channels. In a usage example, at least two hydrophones are serially coupled to a single channel, which can include a daisy chained power over ethernet protocol. The hydrophones can be coupled in various configurations such as a horizontal line, a vertical line, a square, a matrix, a random pattern, an array, and so on. Configurations such as these can enable distributed beamforming. As sound waves reach the hydrophones in the array, they can arrive at each hydrophone at slightly different times. The time difference between the hydrophones can be used to indicate the direction of the sound being detected. The distributed beamforming can determine a bearing and a range of the source of the underwater audio signal.

The flow 100 includes deploying the acoustic sensor 130. The acoustic sensor can be deployed in any body of water such as an ocean, a lake, a river, a pond, an aquarium, and so on. The body of water can include fresh water, salt water, briny water, etc. The sensor can be deployed with a diver; from a surface vessel, a UUV, or a remotely operated underwater vehicle (ROUV); and so on. The acoustic sensor and/or the hydrophones can be submerged, allowing the hydrophones to collect underwater audio signals. The acoustic sensor can optionally be coupled to a buoy, such as a surface buoy, a drifting buoy, a moored buoy, a spotter buoy, an ice buoy, and so on. The buoy can provide power to the embedded sensor. The acoustic sensor can be towed behind a boat or ship to provide monitoring over an area within the body of water. Embodiments include deploying, in a body of water, the acoustic sensor and the one or more hydrophones.

In embodiments, the acoustic sensor and the one or more hydrophones comprise a software-defined hydrophone (SDH). An SDH can be a flexible, reconfigurable DSP paradigm for passive acoustic monitoring. The acoustic sensor can be configured to perform any number of DSP functions on one or more channels. The DSP functions can then be reconfigured at any time. For example, a first audio channel within the acoustic sensor can be programmed to filter frequencies for underwater mammal tracking. At the same time, a second audio channel can be programmed for vessel detection across a different set of frequencies. At any time, any channel can be reconfigured. For example, the second audio channel can be reconfigured on the fly for classification (e.g., inferencing with a machine language model) of sounds across a different frequency spectrum. This configurability can simplify monitoring for various underwater missions, achieve passive acoustic monitoring at scale, save power, reduce reliance on volatile equipment, and enhance the accuracy of marine observation.

The flow 100 includes programming a digital signal processing (DSP) function 140. Embodiments include programming, via software, one or more digital signal processing (DSP) functions of the acoustic sensor, wherein a first DSP function is associated with a first frequency band and the first acoustic channel. The programming can be accomplished via software and can be performed at any time. In a usage example, one or more DSP functions are programmed prior to deploying the sensor. In embodiments, the programming is accomplished remotely 142. Recall that the acoustic sensor can include communications devices such as wireless, cellular communications, ethernet, and so on. Technologies such as these can enable remote programming of the sensor while deployed. In some implementations, the acoustic sensor can be coupled to a buoy or vessel that provides communications to an electronic device such as a server, computer, laptop, handheld device, and so on. The programming can include the use of a server, which can be a cloud server, to establish programming access between a user and the acoustic sensor.

The flow 100 includes receiving, by the first hydrophone, a first underwater audio signal 160. The underwater audio signal can comprise a time series analog signal. The signal can comprise a frequency bandwidth such as 20 Hz-20 KHz, or any other frequency bandwidth associated with the hydrophone. The receiving can include more than one hydrophone. Additional hydrophones can be used for additional frequency range, for distributed beamforming to determine the location of sources of underwater sounds more precisely, and so on. The hydrophones can convert the sound waves into electrical signals and send them to the embedded acoustic controller for DSP analysis, machine learning analysis, and so on.

The flow 100 includes filtering the first audio signal 170. Embodiments include filtering, by the acoustic sensor, the first underwater audio signal, wherein the filtering is based on the first frequency band. A filter can be a device or program process that removes unwanted components or features from an audio signal. The audio signal received from one or more hydrophones coupled to an audio channel can comprise a wider frequency range than the frequency range of interest. For example, a North American right whale (NAWR) can generally perform vocalizations in a range of 10 Hz to 4 KHz. By contrast, a hydrophone can collect audio signals comprising a wider frequency range, for example from 10 Hz to 1 MHz. To isolate the frequency band of interest, the audio collected from the hydrophones can be filtered to remove specific frequencies or frequency bands from the acoustic signal that are not included in the first frequency band selected by the acoustic sensor. The filtering can alter the amplitude and/or phase of the acoustic signal with respect to frequency. The filter can be analog or digital, continuous-time or discrete-time, linear or non-linear, causal or non-causal. The filtering can implement a low pass filter, a high pass filter, a band pass filter, a band stop filter, an all-pass filter, a comb filter, or any other suitable filter. The filtering can be performed on analog or digital signals (e.g., the signal can be sampled prior to filtering). The programming can control details of the filtering such as frequencies rejected, and so on.

The flow 100 includes analyzing the first audio signal 172. Embodiments include analyzing, by the acoustic sensor, the first underwater audio signal, wherein the analyzing includes sampling the first underwater audio signal, and wherein the analyzing is based on the first DSP function associated with the first acoustic channel. The analyzing can produce results of the DSP function that was selected. For example, the acoustic sensor can classify an underwater audio sound, track the location of a fish tracker, record data, detect vessels, detect aquatic animals, monitor underwater objects or activity, and so on. In embodiments, the analyzing includes converting, by an embedded acoustic controller within the acoustic sensor, the first underwater audio signal to a first digital signal 174. The converting can be accomplished via an analog to digital conversion (ADC) process. The ADC can include a programmable sampling frequency, resolution, as well as other factors. For example, the ADC can sample analog signals received from a hydrophone at a rate of two megasamples-per-second (2 Msps). The sampling rate can be the Nyquist rate, which can be two times the first frequency band. The sampling rate can be higher or substantially higher than the Nyquist rate. Any other suitable rate can be used. Each sample taken can be represented by a number of bits, called the resolution of the sample, or “bit depth.” In general, a large bit depth can lead to a higher precision at the cost of larger data sets. In a usage example, the resolution comprises 24-bits. Any bit depth can be used for any audio channel. The frequency, resolution, and other parameters can be programmed, reprogrammed, etc. at any time. Once converted to a digital signal, the DSP functions of the acoustic sensor can be applied to the underwater audio signals that were captured by the hydrophones. Updating the resolution can be useful to match the accuracy needs of certain DSP and/or classification functions, etc. In some circumstances, such as recording data, the resolution can be modified to limit storage requirements and extend capture times.

In embodiments, the programming includes a second DSP function, wherein the second DSP function is associated with a second frequency band and a second acoustic channel within the one or more acoustic channels, and wherein a second hydrophone within the one or more hydrophones is associated with the second acoustic channel. As described above and throughout, the acoustic sensor can support multiple hydrophones and audio channels. The channels can be associated with a single hydrophone, multiple hydrophones, or zero hydrophones (e.g., unused). The association between channels and hydrophones can be changed via programming. Thus, while the first DSP function, such as vessel detection, is operating on the first channel over a first frequency band, a second DSP function, such as a fish tracker, can be programmed to run on a second channel over a second frequency band. Alternatively, hydrophones coupled to different audio channels can be programmed to execute the same DSP function. Any parameter of any sensor channel can be updated by software at any time.

In embodiments, the receiving includes obtaining, by the second hydrophone, a second underwater audio signal 180. Recall that a first hydrophone can receive a first underwater audio signal via a first audio channel. The first underwater audio signal can be filtered, converted to a digital signal, and analyzed by a DSP function, machine learning function, etc. of the sensor. At the same time, a second underwater audio signal can be obtained by a second hydrophone via a second audio channel. The underwater signal can be the same signal. Each channel can operate independently and thus can perform filtering, ADC, and DSP functions concurrently with different parameters, features, functions, etc.

Embodiments include filtering, by the acoustic sensor, the second underwater audio signal 182, wherein the filtering is based on the second frequency band. For example, while a first audio channel can be set to capture North American right whale (NAWR) vocalization between 10 Hz to 4 K Hz, a second audio channel can be set to capture echolocation sperm whale clicks, which can be between 15 Hz and 200 KHz. These signals can be collected, filtered, sampled, and analyzed in parallel by the sensor. Other embodiments include evaluating, by the acoustic sensor, the second underwater audio signal 184, wherein the analyzing is based on the second DSP function associated with the second acoustic channel. In a usage example, a first channel can be programmed to analyze vessels while a second channel can be programmed to evaluate mammal sounds. In embodiments, the analyzing and the evaluating occur in parallel.

A plurality of other functions can be included within the acoustic sensor. The functions can comprise digital signal processing (DSP) functions such as analog to digital (A/D) conversion or digital to analog (D/A) conversion; acoustic echo cancellation; gain control; mathematical functions such as add, subtract, multiply, and divide; frequency domain transformations such as a Fourier transform or cepstrum analysis; and so on. The acoustic sensor can be programmed at any time to implement various DSP functions on the acoustic signal for analysis. An application program interface (API) can be provided to allow the user to seamlessly program the acoustic controller in a plurality of programming environments. The programming can be accomplished remotely. The acoustic sensor and hydrophones can comprise a software-defined hydrophone.

The flow 100 includes reprogramming the acoustic sensor 190. At any time, any aspect of the acoustic sensor, such as hydrophone-acoustic channel mapping, frequency filtering, sampling, DSP function, and so on, can be reprogrammed. Embodiments include reprogramming the acoustic sensor. As described above, the acoustic sensor can provide a flexible programming environment that can be reconfigured prior to deployment or during deployment. The programming can occur on site or remotely. Any audio channel on the acoustic sensor can be reconfigured to perform any available DSP function of the acoustic sensor. Recall that a first DSP function can be associated with a first frequency band and a first acoustic channel on the acoustic sensor. In embodiments, the reprogramming adjusts the first frequency band 192. For example, the first audio channel can be used to monitor right whale (NAWR), then changed to listen for sperm whale clicks, then updated again to capture acoustic release signals. Each of these functions can operate over a unique frequency band. Alternatively, these three functions can be implemented on three separate channels. Each band of each channel can be adjusted independently to alter the function of the sensor.

In embodiments, the reprogramming updates a resolution 194 of the sampling the first underwater audio signal. The resolution, sampling rate, and other sampling parameters can be reprogrammed. As described above, resolution can refer to an amount of data captured each time a signal is sampled and can be referred to as “bit depth.” In general, a large bit depth can lead to a higher precision at the cost of larger data sets. In a usage example, the resolution comprises 24 bits. However, the bit depth can be reprogrammed for less resolution, such as 16 bits, if storage space is limited. In embodiments, the reprogramming changes the first DSP function 196. A DSP function associated with any audio channel can be updated, changed, modified, etc. For example, a first audio channel within the acoustic sensor can be configured, prior to deployment, to record audio data from a coupled hydrophone. At any time, the channel can be reconfigured to perform another function, such as classification of underwater audio signals received from the coupled hydrophone. In embodiments, the programming includes reassociating the first hydrophone 198 with a second channel within the one or more acoustic channels. Not only can DSP programs be changed, but hydrophones coupled to the sensor can be programmatically coupled to a different channel. Consider a case where a first hydrophone is coupled to a first audio channel within the sensor which performs a first DSP function over a first frequency band. In parallel, a second hydrophone can be coupled to a second audio channel within the sensor which performs a second DSP function over a first frequency band. Now consider the case where the first hydrophone fails. If the first DSP function is deemed more critical than the second, the second hydrophone can be routed to the first audio channel to continue performance of the first DSP function. In like manner, any hydrophone can be mapped and/or routed to any audio channel on the acoustic sensor. In addition, this disclosure includes the ability to sum multiple input sources, such as modular transducers, etc., that are coupled to any acoustic channel.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

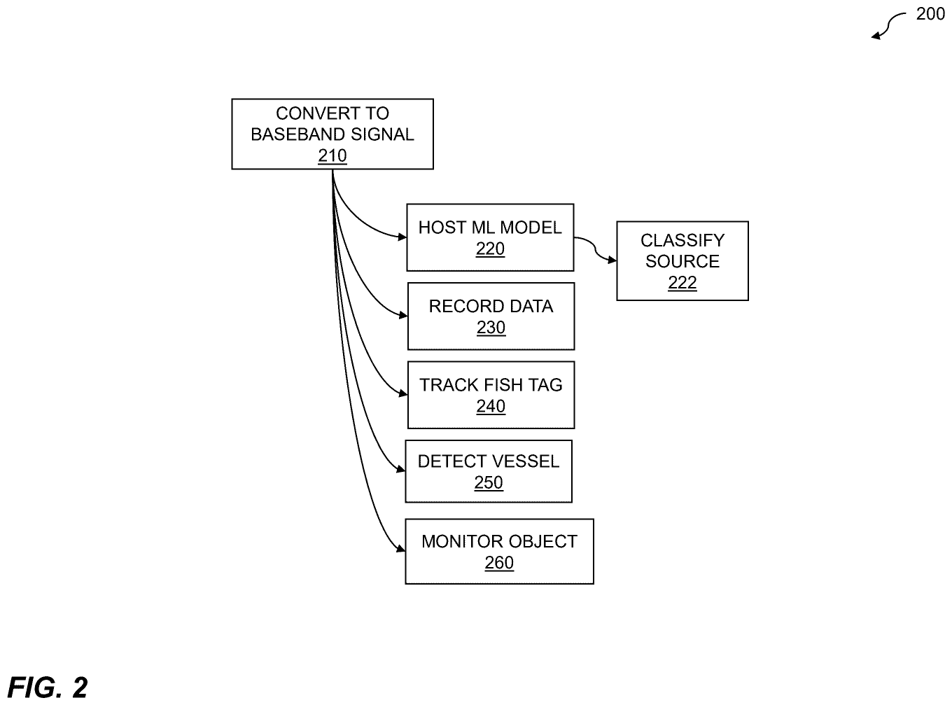

FIG. 2 is a flow diagram for programming DSP functions. The acoustic sensor can perform a plurality of DSP functions on captured audio signals from vessels, marine animals, human activity, and so on. The programmability of the sensor can enable a software-defined hydrophone. The flow 200 includes converting to a baseband signal 210. In embodiments, the embedded acoustic controller includes a digital down converter (DDC), wherein the DDC converts the first digital signal to a low frequency baseband signal. Recall that the acoustic sensor can include an embedded acoustic controller which can convert a captured underwater audio signal to a digital signal for processing. The embedded acoustic controller can include one or more DDCs. A DDC is a device which can simplify DSP functions by shifting a sampled digital signal to be centered at baseband (e.g., 0 Hz). Each channel can perform digital down conversion of a digital signal to baseband. One or more DDCs can be included with the controller. The DDC can include one or more functions such as a multiplier, oscillator, low pass filter, decimator, and so on.

The flow 200 includes hosting a machine learning (ML) model 220. A machine learning model is a computer program that can recognize and/or classify patterns in data. The recognized patterns can be used to make predictions and/or identify the same or similar patterns in other sets of data. Any type of machine learning model can be employed by the acoustic sensor including a neural network, convolutional neural network, support vector machine, large language model (LLM), small language model (SLM), TinyML™ model (a ML model that can be implemented on small, resource-constrained devices, including microcontrollers, with extremely low power consumption), and so on. In some embodiments, the embedded acoustic controller can operate on less than 100 peak milliwatts (mW) of power. Thus, a TinyML™ machine learning model can run on a microcontroller within the acoustic sensor powered by a small, lightweight battery for long periods of time without requiring physical maintenance. Recall that the acoustic sensor can include an embedded acoustic controller. In embodiments, the embedded acoustic controller hosts a machine learning model.

Recall that a first DSP function can be programmed into the acoustic sensor. In embodiments, the first DSP function includes classifying, by the machine learning model, an underwater signal source 222. The classifying, which can be inferencing, can be accomplished by the ML model. The classification and/or inferencing can be based on selecting one or more aspects of the underwater audio signal. The one or more aspects can include the length of a specific sound, noise level, and/or other characteristics of the sound. The one or more aspects can include signal energy within frequency bands, signal energy within wavelet scales, statistics of the underwater audio signal, and/or other aspects of the signal to maximize the accuracy of the classification using principal component analysis. The classification can be further based on creating one or more feature vectors by the embedded acoustic controller. The one or more feature vectors can be based on the one or more aspects as described above. A feature vector is a mathematical representation of an object or data point in machine learning. It serves as a numerical summary of the features or attributes that describe the object or data point. A feature vector can contain multiple elements related to an object, such as described above. The classification can be further based on choosing one or more transformations to apply to the one or more feature vectors. Transforming an audio signal can modify the way in which the signal is represented. Audio signals can be transformed in one or more ways to allow for various types of analysis. For example, a Fast Fourier Transformation (FFT) converts an audio signal from a time domain to a frequency domain. This allows the signal to be analyzed for the various frequency components and can be used for audio compression, noise reduction, and so on. Other transformations include Mel-Frequency Cepstral Coefficients (MFCCs), chroma features, spectral contrast, lossy compression, low-and high-pass filters, and so on. In embodiments, transforming aspects of underwater signals can allow the signals to be separated from one another and identified based on their unique characteristics. The combination of acoustic signal aspects, feature vectors, and transformations can be used by the machine learning model to classify the one or more sources of acoustic signals detected by the hydrophones.

The classification can be based on one or more templates. A template can be a predefined group of settings or variables that can be used in combination to accomplish a purpose or match a set of identified conditions. A plurality of variables can be controlled by the one or more templates to search for a specific acoustic profile. The acoustic profile can identify a specific type of marine vessel, marine mammal, fish, etc. For example, a template to track a surface vessel can be programmed to include which bandwidth and frequencies to filter; which acoustic signals to analyze; classification processes; source, direction, and velocity analyses; and so on. The template can include which cloud server or operations platform to send the acoustic data to, how often to refresh and forward the data, and so on.

In embodiments, the first DSP function includes recording data 230. The acoustic data captured by the hydrophones can be recorded in raw form, in filtered form, in digital form, as a baseband signal, as a transformed stream such as described above, and so on. Further, the acoustic data can be stored as one or more transformed data streams created by the machine learning analysis and can be saved as an audio recording. The audio recording can be saved on an appropriate memory device within the acoustic sensor, such as a hard drive, solid state drive, flash drive, and so on. In some examples, data can be sent to a cloud server for storage. As described earlier, to save space on the storage device, the bit depth can be changed.

In embodiments, the first DSP function includes tracking a fish tag. The tracking can include detection of a fish tag, as well as decoding of the fish tag 240. The hydrophones can collect acoustic fish tag data emitted by an acoustic tag. The fish tag data can be sent with any frequency including radio, ultrasonic, satellite, and so on. Received fish tag data can be identified by the machine learning model, compared to known fish tag signatures by the embedded acoustic controller, etc. The one or more hydrophones can be used to detect range, speed, direction, and so on of the fish tag. This information can be stored, sent to a user, uploaded, etc. In embodiments, the first DSP function includes detecting a vessel 250. Known acoustic data patterns of one or more surface and underwater vessels can be compared to acquired underwater audio signals. Vessels such as ships, UUVs, etc. can be identified by the machine learning model, compared to known vessel signatures by the embedded acoustic controller, etc. Range, speed, direction, etc. of the vessel can be stored, sent to a user, uploaded, and so on. In embodiments, the first DSP function includes monitoring an underwater object of interest 260. The machine learning model can be trained to analyze and identify human-caused and natural acoustic sounds such as underwater drilling and pumping activities, fishing, lobster trapping, seismic activity, and so on. The programming can include using one or more hydrophones located on one or more acoustic sensors to monitor underwater objects and activities and forward the data to a cloud server for further analysis or tracking purposes. Other DSP functions, such as those described above, can be used to monitor the object. In some cases, the monitoring of an underwater object of interest can include automated recording, tracking, and monitoring of acoustic data that cannot be identified by the machine learning model. The acoustic data can be saved, forwarded to a user, uploaded, etc. for additional analysis.

In embodiments, the first DSP function includes signal intelligence. Functions within the embedded controller can be used to intercept and analyze communication signals such as can be emitted from devices such as acoustic modems, low-frequency radio systems, etc. Other non-communication signals, such as SONAR pulses, propeller noise, engine sounds, and so on can also be analyzed. These signals can be used to gain data on range, speed, direction, etc. of other vessels and/or activities. The first DSP function can comprise many other functions such as surface vessel detection, underwater unmanned vehicle (UUV) detection, human diver detection, environmental monitoring (such as detecting natural and manmade activities), passive acoustic monitoring of coral reefs, passive acoustic monitoring of oyster reefs, and so on.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

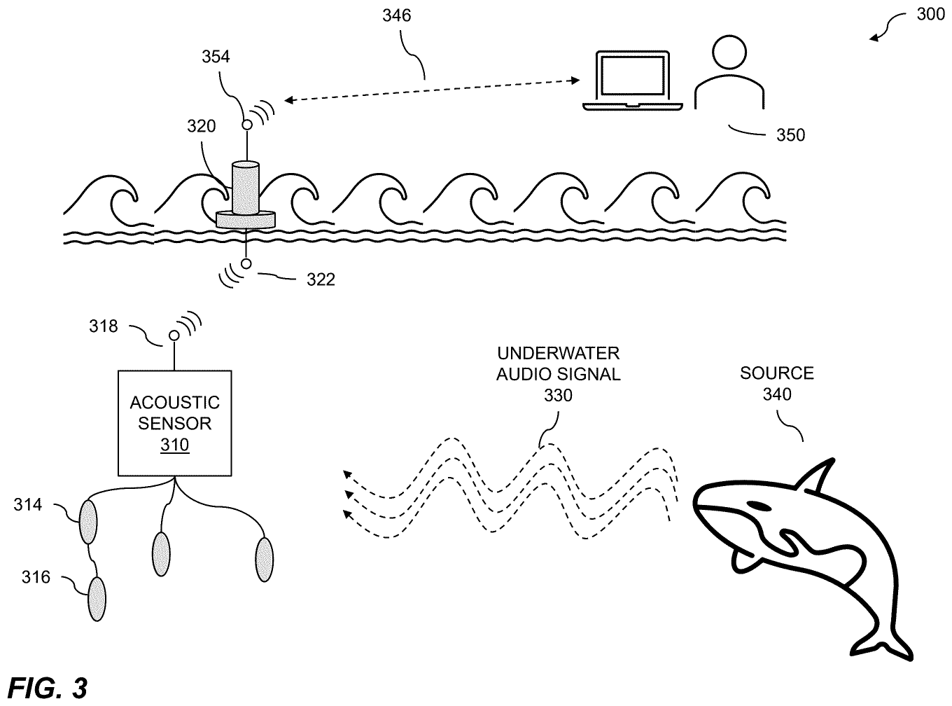

FIG. 3 is an infographic for automated passive acoustic monitoring. Analysis of underwater audio signals is enabled by an acoustic sensor with hydrophones. The acoustic sensor can include any number of embedded acoustic controllers, embedded processors, acoustic controllers, digital down converters, filters, processors, memory devices, storage devices, neural processors, I/O devices and ports such as Ethernet, wireless communications devices such as Bluetooth, Zigby, etc., broadband communications devices such as 5G, satellite communications, power supplies, batteries, and so on. The sensor can include capabilities for running machine learning (ML) models, such as small language models (SLMs), TinyML™ models, and so on. The machine learning models can comprise edge artificial intelligence (AI). The sensor can include a watertight enclosure to protect electronics, such as those mentioned above. The watertight enclosure can be made of metal, plastic, another material, or a combination of materials. Watertight plugs for connecting one or more hydrophones to the sensor can be included in the watertight enclosure. The acoustic sensor can function with one or more hydrophones. In embodiments, the acoustic sensor and the one or more hydrophones comprise a software-defined hydrophone (SDH).

The flow 300 includes an acoustic sensor 310. The sensor can convert sound waves into electrical signals which can be analyzed and processed. The acoustic sensor can include one or more embedded acoustic controllers. The embedded acoustic controller can run a known instruction set architecture, a low power architecture, a custom set of instructions, etc. The embedded acoustic controller can run custom audio functions; digital signal processing (DSP) functions such as signal filtering, logical operations, signal synchronization, modulation/demodulation, encoding/decoding, etc.; and so on. The user can program the custom audio functions and DSP functions. The programming can be accomplished remotely while the acoustic sensor is deployed underwater. The embedded acoustic controller can enable a smaller chip size than a general purpose microprocessor and thus can consume less power, enabling long-term underwater operations without recharging or replacing batteries which can supply power to the acoustic sensor. The embedded acoustic controller can host a machine learning model. The machine learning model can include any of a number of machine learning algorithms including a CNN, an LLM, an SLM, an SVM, a linear regression, a KNN algorithm, a TinyML™ model, etc. Embodiments include accessing an acoustic sensor, wherein the acoustic sensor includes one or more acoustic channels, wherein the acoustic sensor is coupled to one or more hydrophones, and wherein a first hydrophone within the one or more hydrophones is associated with a first acoustic channel within the one or more acoustic channels.

The acoustic sensor is coupled to one or more hydrophones. Two or more hydrophones can be serially coupled 314, 316 through a wired or wireless protocol. The wired protocol can include any available communications protocol including PCI-Express (PCI-E), RS-232, SPI, PCI Express, and so on. The communications can be enabled by a customized 2-wire interface for power and communications between coupled hydrophones. The communications can be based on open standards such as Bristlemouth. Wireless protocols can include an acoustic modem, acoustic link, laser, radio transmissions, and so on. When serially coupling hydrophones, a daisy chained power over ethernet protocol can be used. Serially coupling hydrophones can enable distributed beamforming, wherein the distributed beamforming localizes a source of underwater audio signals. The distributed beamforming can include determining a bearing and range of a source of the underwater audio signal. Coupling hydrophones can enable one or more customized array configurations. The array configurations can include a vertical array, a horizontal array, a square, a matrix, a random pattern, and so on. The acoustic sensor can include any number of acoustic channels. The hydrophones can be coupled to any available audio channel. More than one hydrophone can be coupled to an audio channel.

Embodiments include deploying, in a body of water, the acoustic sensor and the one or more hydrophones. The acoustic sensor can be submerged and coupled 318 to a buoy 320. The coupling can include a wire (not shown) for power, charging, and/or data communications. The coupling can include wireless communication methods such an acoustic modem, a laser, radio transmissions, and so on. A matching communication method 322 can be included in a buoy to enable 2-way communication with the acoustic sensor. The acoustic sensor can include a power supply. The power supply can comprise a battery, a rechargeable battery, and so on. The power supply can include a power cable coupled to another power source such as a buoy, an unmanned underwater vehicle (UUV), and so on. Embodiments include programming, via software, one or more digital signal processing (DSP) functions of the acoustic sensor, wherein a first DSP function is associated with a first frequency band and the first acoustic channel. Any number of sources can be processed substantially simultaneously. In embodiments, the programming includes a second DSP function, wherein the second DSP function is associated with a second frequency band and a second acoustic channel within the one or more acoustic channels, and wherein a second hydrophone within the one or more hydrophones is associated with the second acoustic channel.

The flow 300 includes an underwater audio signal 330, which can be generated from a source 340, or a predicted source. Embodiments include receiving, by the first hydrophone, a first underwater audio signal. Other sources of other signals can be included in the underwater audio signal. The predicted source can comprise any natural or manmade sound found in the underwater environment. Examples can include surface noises such as boats, rain, lightning, and so on. Other examples of predicted sources can be activities such as swimming, diving, fishing, boating, drilling, and so on. Further examples of predicted sources can be natural occurrences such as underwater earthquakes. Other examples of predicted sources include underwater animals including fish and mammals. Many other predicted sources can generate underwater audio signals. The predicted source can comprise a marine mammal. The predicted source can comprise a species of marine mammal. The predicted source comprises an individual animal within the species of marine mammal. Any signal from the above-named sources can be received, detected, filtered, converted to digital format, down converted, classified, analyzed, etc. by the acoustic sensor.

The underwater audio signal can be analyzed. Embodiments include analyzing, by the acoustic sensor, the first underwater audio signal, wherein the analyzing includes sampling the first underwater audio signal, and wherein the analyzing is based on the first DSP function associated with the first acoustic channel. The acoustic sensor can be equipped to perform a number of DSP functions. In embodiments, the first DSP function includes recording data. In some embodiments the first DSP function includes tracking a fish tag. In other embodiments, the first DSP function includes detecting a vessel. In some embodiments, the first DSP function includes monitoring an underwater object of interest. In embodiments, the first DSP function includes signal intelligence. Other DSP functions can be included. As described above, in embodiments, the embedded acoustic controller hosts a machine learning model.

In embodiments, the first DSP function includes classifying, by the machine learning model, an underwater signal source. After the machine learning model has classified one or more sources of the underwater audio signal, the acoustic sensor can store data, upload results, send 346 the predicted source to a user 350, and so on. The sending can be accomplished using a communications device 354. The communications device is included in the buoy. The communications device can be based on wireless technology, cellular technology such as long term evolution (LTE) broadband wireless or 5G, Bluetooth, satellite communications, or another communications method or protocol used to send data to a user. The communications device can send data from the acoustic sensor directly to a vessel, UUV, or another aquatic vehicle where a user can be located.

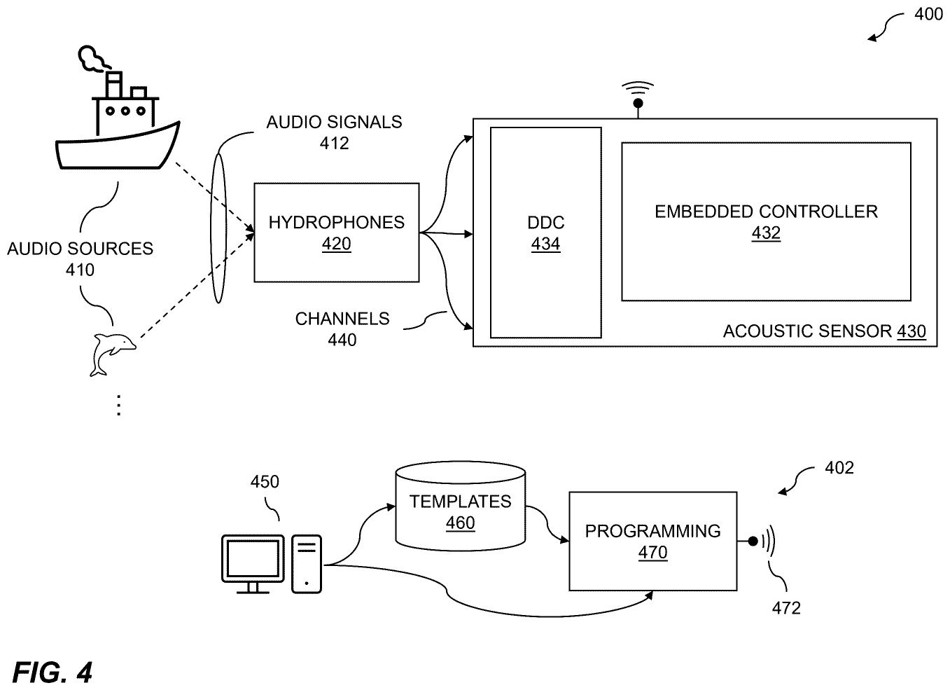

FIG. 4 is an infographic for a software-defined hydrophone with acoustic sensor functions. An acoustic sensor and one or more hydrophones can enable a software defined hydrophone with acoustic sensor functions and machine learning. The infographic 400 includes one or more audio sources 410. The audio sources can emanate from vessels such as ships, submarines, UUVs, etc.; from aquatic life such as whales, dolphins, etc.; from activities such as fishing, mining, etc.; and from natural occurrences such as rain, earthquakes, and so on. The audio sources can produce audio signals 412 which can be transmitted under water. The audio signals can be detected by one or more hydrophones 420 coupled to an embedded controller 432. Any number of hydrophones can be coupled to the acoustic sensor. The hydrophones can comprise a plurality of configurations. For example, two or more hydrophones can be serially coupled which can enable distributed beamforming. The hydrophones can be arranged into one or more customized array configurations. The array configurations can include a vertical array, a horizontal array, a square, a matrix, a random pattern, and so on. The hydrophones can be coupled to the acoustic sensor 430 through a plurality of audio channels 440. A channel can refer to a path where audio can be sent. The audio channels can allow the sensor to receive signals for processing. The acoustic channels can be programmable via software such that each channel can be assigned a frequency, bandwidth, filter, digital signal processing (DSP) function, etc. The plurality of hydrophones can include a first hydrophone. Embodiments include receiving, by the first hydrophone, a first underwater audio signal.

In other embodiments, the receiving includes filtering, by the acoustic sensor, the first underwater audio signal, wherein the filtering is based on the first frequency band. The filtering can be based on a low-pass filter, a band-pass filter, a high-pass filter, and so on. The filtering can narrow the audio signal to only those components of interest. For example, when capturing dolphin clicks, a filter can be set to focus on frequencies between 20 Hz to 150 KHz. Any other frequency range(s) can be chosen. The filtering can be programmed. Recall that the audio signal can be analyzed. In embodiments, the analyzing includes converting, by an embedded acoustic controller 432 within the acoustic sensor 430, the first underwater audio signal to a first digital signal. Conversion to a digital signal can enable other DSP functions performed by elements of the embedded acoustic controller, or another controller, embedded processor, etc. For example, the controller can record data, track an object, perform signal intelligence, etc. In embodiments, the embedded acoustic controller includes a digital down converter (DDC) 434, wherein the DDC converts the first digital signal to a low frequency baseband signal. The DDC can be within the controller or can be a separate element within the acoustic sensor (as shown in infographic 400). As described earlier, a DDC can simplify DSP functions mentioned above by shifting a sampled digital signal to be centered at baseband (e.g., 0 Hz).

The controller can host a machine learning (ML) model. The ML model can be used to identify and classify natural and human-caused aquatic sounds received by the hydrophones and sent to the machine learning model by the embedded acoustic controller. The ML model can be based on a TinyML™ model, or another ML model. In some embodiments, the embedded acoustic controller can operate on less than 100 peak milliwatts (mW) of power. Thus, a TinyML™ machine learning model can run on a microcontroller powered by a small, lightweight battery for long periods of time without requiring physical maintenance. The ML model can be programmed to operate on one or more aspects of a captured underwater signal. The one or more aspects can include the length of a specific sound, noise levels, and other characteristics of the sound. The one or more aspects can include signal energy within frequency bands, or signal energies within wavelet scales. The acoustic sensor can also be programmed to create one or more feature vectors based on the one or more aspects that were selected. The programming can include choosing one or more transformations to apply to the one or more feature vectors. The programming can be based on one or more templates (described below). A plurality of ML variables can be controlled by the one or more templates to search for a specific acoustic profile. The acoustic profile can identify a specific type of marine vessel, marine mammal, fish, etc. For example, a template to track a surface vessel can be programmed to include which bandwidth and frequencies to filter; which acoustic signals to analyze; classification processes; source, direction, and velocity analyses; and so on. The template can include which cloud server or operations platform to send the acoustic data to, how often to refresh and forward the data, and so on.

The infographic 402 shows an example of programming an acoustic sensor. Embodiments include programming, via software, one or more digital signal processing (DSP) functions of the acoustic sensor, wherein a first DSP function is associated with a first frequency band and the first acoustic channel. Any DSP function can be assigned to any audio channel within the embedded processor. In embodiments, the programming 470 is accomplished remotely. Once deployed, the filtering, sampling, performance of any included DSP function, etc. can be changed. The programming can be accomplished by a device 450 such as remote server, computer, laptop, mobile device, etc. The device programming sensor can be located anywhere in the world with Internet and/or remote network access to the acoustic sensors. In some embodiments, programming instructions can be transmitted 472 to a cloud storage platform for subsequent transmission to one or more acoustic sensors. The programming can be based on an application program interface (API). The APIs can be used to program components included in the acoustic sensor, including the embedded controller, machine learning components, memory components, processors, hydrophones, transmission components, and so on. The APIs can be used to edit, update, add, or remove programming from one or more elements of the acoustic sensor and hydrophones. In embodiments, the APIs can generate result codes to report the results of the updating process. The APIs can be used to interface the sensor with various software packages. The programming can include one or more templates 460 which can pre-define certain functions. For example, when observing sperm whales, a template can specify channel parameters for a hydrophone configuration, frequency range, sampling rate, DSP function and/or machine learning model to recognize and track sperm whales. Any number of templates can be provided to enable ease of programming the acoustic sensor functions.

Embodiments include reprogramming the acoustic sensor. Once deployed, the sensor can be reprogrammed at any time. In a usage example, an embedded sensor is deployed with two operational functions operating on two channels. While in use, the sensor can be reprogrammed to include a third function on a third channel. In embodiments, the reprogramming adjusts the first frequency band. In embodiments, the reprogramming updates a resolution of the sampling the first underwater audio signal. In some embodiments, the reprogramming changes the first DSP function. In other embodiments, the reprogramming includes reassociating the first hydrophone with a second channel within the one or more acoustic channels. Any aspect and/or function of the embedded sensor can be reprogrammed while deployed.

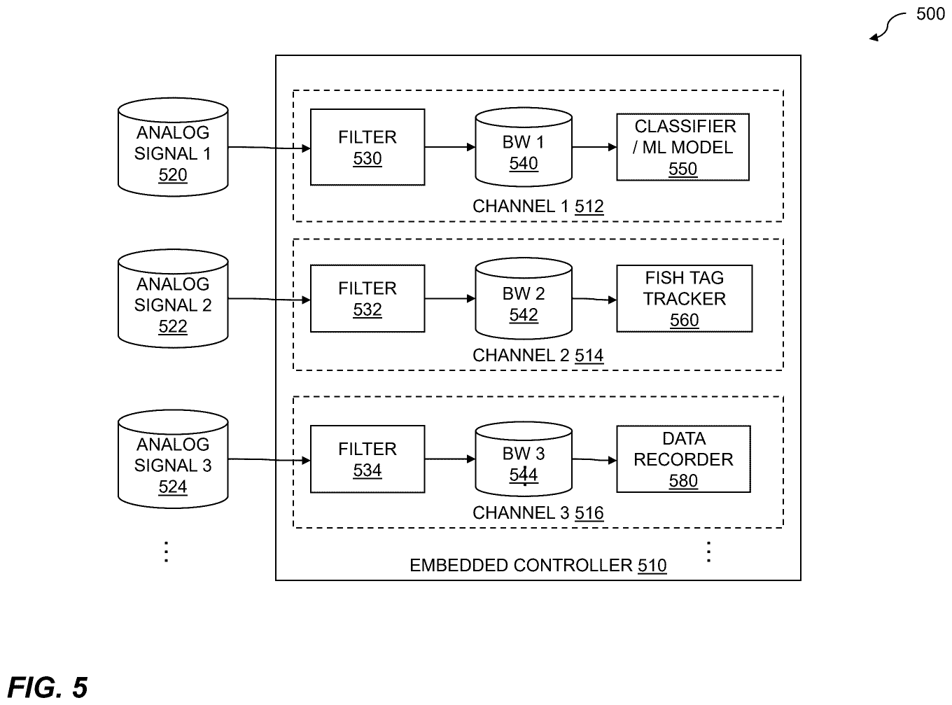

FIG. 5 is a block diagram 500 of an embedded controller. As described above and throughout, an acoustic sensor can include an embedded controller. The embedded controller 510 can be coupled to one or more audio channels 512, 514, 516. Signals received over the audio channels can be filtered, converted to a digital signal, applied to a DSP function, sent to a machine learning model, and so on to provide useful passive acoustic monitoring functions. Recall that one or more hydrophones can receive an underwater audio signal. The hydrophones can convert the sound waves into electrical signals and may also amplify the signals with a pre-amp. The audio signals 520, 522, 524, which can be analog signals, can then be sent to the embedded acoustic controller for analysis. The acoustic sensor can include a first hydrophone. Embodiments include receiving, by the first hydrophone, a first underwater audio signal. The acoustic sensor can include a second hydrophone. In some embodiments, the receiving includes obtaining, by the second hydrophone, a second underwater audio signal. Any number of hydrophones and signals can be coupled to the acoustic sensor. In embodiments, the acoustic sensor and the one or more hydrophones comprise a software-defined hydrophone (SDH).

The signals that were collected by the hydrophones and sampled can be filtered to restrict the signals to the signal frequency range of interest for the DSP function that was selected for each channel. A filter is a device or program process that removes unwanted components or features from an audio signal. The filtering can remove specific frequencies or frequency bands from each acoustic signal that are not included in the frequency band selected by the acoustic sensor for the selected channel. In some embodiments, the filtering can alter the amplitude and/or phase of the acoustic signal with respect to frequency. The filter can comprise a low-pass filter, high-pass filter, band-pass filter, etc. The filter can reject a frequency range. The filter can be analog or digital, continuous-time or discrete-time, linear or non-linear, causal or non-causal. A first underwater signal can be received by a first hydrophone and filtered in accordance with a first frequency band appropriate for a first underwater source and a first DSP function selected. The one or more hydrophones can be capable of receiving acoustic data across a wide range of frequencies, for example, from 1 Hz to 500 kHz. One or more filters can be used to select subsets of the input frequency band to process. For example, a filter 530 for bandwidth 1 540 can remove all frequencies from the audio signals except the frequencies from 10 Hz to 20 kHz, another filter 532 for bandwidth 2 542 can remove all frequencies from the audio signals except the frequencies from 69 kHz to 417 kHz, and a third filter 534 for bandwidth 3 544 can remove all frequencies from the audio signal except from 20 Hz to 20 kHz. In embodiments, the receiving includes filtering, by the acoustic sensor, the first underwater audio signal, wherein the filtering is based on the first frequency band. In parallel, a second underwater signal can be captured by a second hydrophone and filtered in accordance with a second frequency band appropriate for a second underwater source and a second DSP function selected. Embodiments include filtering, by the acoustic sensor, the second underwater audio signal, wherein the filtering is based on the second frequency band.

Signals 540, 542, and 544 can be converted to digital signals by one or more analog-to-digital (ADC) converters. The converters can be included in the acoustic controller (not shown) or provided in addition to the functions provided by the acoustic controller. In some cases, the ADC can be accomplished prior to the filtering. The ADC process can include sampling an analog signal. The sampling can occur at a sampling rate which can be programmed. The ADC can include a quantization step which can be based on a resolution or bit depth. The quantization step can map each value to a nearest value within the discrete bits in the bit depth that was selected. The ADC can include an encoding step which can convert quantized values into a digital output which can be analyzed, manipulated, etc. by the embedded controller.

Recall that the first underwater signal can be analyzed by the acoustic sensor based on a first DSP function associated with a first acoustic channel. As shown in block diagram 500, channel 1 has been configured to perform a classification 550 (e.g., inference) function on the first digital signal. For example, the filtered bandwidth 1 digital data can be used with a TinyML™ machine learning model running on the embedded controller to classify sources of audio signals that are detected within the 10 Hz to 20 KHz frequency range, according to the band that was filtered. The TinyML™ model can determine whether the signal received on channel 1 is a whale, a dolphin, a human activity, a vessel, and so on. Other processing can determine the bearing and range of the source of the signal that was classified. In embodiments, the embedded acoustic controller hosts a machine learning model. In embodiments, the first DSP function includes classifying, by the machine learning model, an underwater signal source.

The block diagram 500 also shows that channel 2 has been configured to perform a fish tracking function 560 on the second digital signal. That is, channel 2 can be configured to track the location of a monitor that sends a specific signal tracking the location of a fish, shark, mammal, etc. The embedded controller can determine if the fish tracking signal has been received and provide bearing, range, speed, etc. of the tracked animal or object. The block diagram 500 shows that channel 3 has been configured as a data recorder 580. Any aspect of the signal collected can be stored including one or more aspects, feature vectors, and/or transformed data associated with a machine learning model. The data can be stored locally on the acoustic sensor, uploaded to a cloud server or another device, sent to a user, etc. The acoustic data captured by the hydrophones can be recorded in raw form as well as storing one or more digital streams created and/or filtered. The stored audio can then be evaluated later for other DSP functions such as surface vessel detection, underwater unmanned vehicle (UUV) detection, human diver detection, environmental monitoring (such as detecting natural and manmade activities), passive acoustic monitoring of coral reefs, passive acoustic monitoring of oyster reefs, and so on. The processing within each of the three channels shown can occur independently and in parallel. Other channels can be included in the embedded controller for additional parallel analysis. Embodiments include analyzing, by the acoustic sensor, the first underwater audio signal, wherein the analyzing includes sampling the first underwater audio signal, and wherein the analyzing is based on the first DSP function associated with the first acoustic channel. Other embodiments include evaluating, by the acoustic sensor, the second underwater audio signal, wherein the analyzing is based on the second DSP function associated with the second acoustic channel. In embodiments, the analyzing and the evaluating occur in parallel.

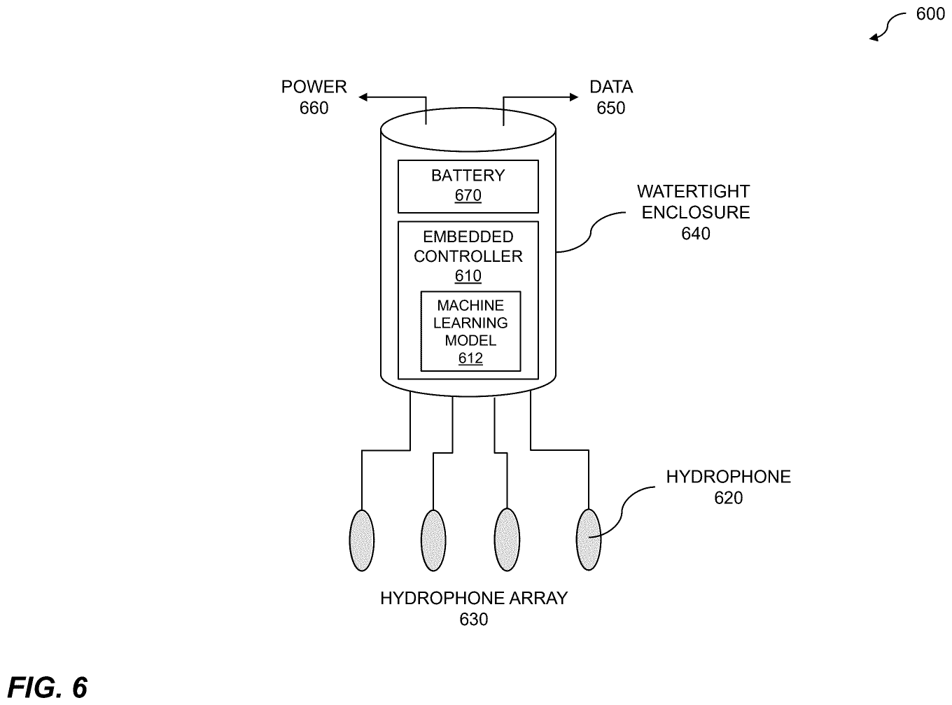

FIG. 6 is a diagram of an acoustic sensor with hydrophones. An acoustic sensor enables passive acoustic monitoring. An acoustic sensor and one or more hydrophones comprise a software-defined hydrophone (SDH). The diagram 600 includes an acoustic sensor. The acoustic sensor can include an embedded acoustic controller 610. The embedded acoustic controller can perform a plurality of DSP functions, host a machine learning model 612, and so on. In some implementations, the acoustic controller can perform ADC functions such as sampling and filtering. In other implementations, other electronic components are included to perform these functions. The acoustic sensor can include a plurality of embedded acoustic controllers. The sensor can include a processor, memory, input/output peripherals, DSP hardware accelerators, a neural processor, and so on. Any of these elements can be provided on the acoustic processor. Data storage can be included on the controller or housed on separate low-power memory chips within the sensor.

The acoustic sensor can be coupled to one or more hydrophones 620. Each hydrophone in the one or more hydrophones can be coupled to a channel within an embedded acoustic controller. Two or more hydrophones can be serially coupled to an audio channel. The serially coupling can include a daisy chained power over ethernet protocol. The serially coupling can enable one or more customized hydrophone array configurations 630. The array configurations can include a horizontal line, a vertical line, a square, a matrix, a random pattern, and so on. The array can be towed horizontally behind a boat or ship. The serially coupling can enable distributed beamforming. As sound waves reach the hydrophones in the array, they arrive at each hydrophone at slightly different times. The time difference between the hydrophones can be used to indicate the direction of the sound being detected. Two or more acoustic sensors with hydrophones can be deployed and used together. Time variations between hydrophone arrays can be used to determine the location of sources of sounds more precisely. The distributed beamforming can determine a bearing and a range of the source of the underwater audio signal.

The embedded acoustic controller can be housed in a watertight enclosure. The watertight enclosure can be made of metal, plastic, polymer, or any combination of materials. Watertight plugs for coupling hydrophones to the acoustic embedded controller can be included in the watertight enclosure 640. A data connection 650 can be included on the acoustic sensor for sending data to other acoustic sensors, a buoy, a vessel, a UUV, a diver, a remote user, and so on. The data connection can be bidirectional. The data connection can include a wireless connection, an acoustic modem, photo communications, Bluetooth, 5G, laser communications, and so on. The diagram 600 can include a power connection 660 for the acoustic sensor and/or hydrophones. The power connection can be coupled to another power source such as a buoy, an unmanned underwater vehicle (UUV), and so on to provide power to the acoustic sensor or to charge one or more batteries 670 contained inside the acoustic processor to power the unit. The batteries can be contained within the watertight enclosure. Underwater battery types can include lithium-ion, flooded lead-acid (FLA), sealed lead-acid (SLA), absorbed glass mat (ACM), aluminum-water batteries (which use seawater to operate), and so on. Alternatively, the power connection can supply power directly to all internal components of the acoustic sensor. Power and data connections can be included in the same conduit, serviced by a single wire via a power over Internet (PoI) protocol, and so on.

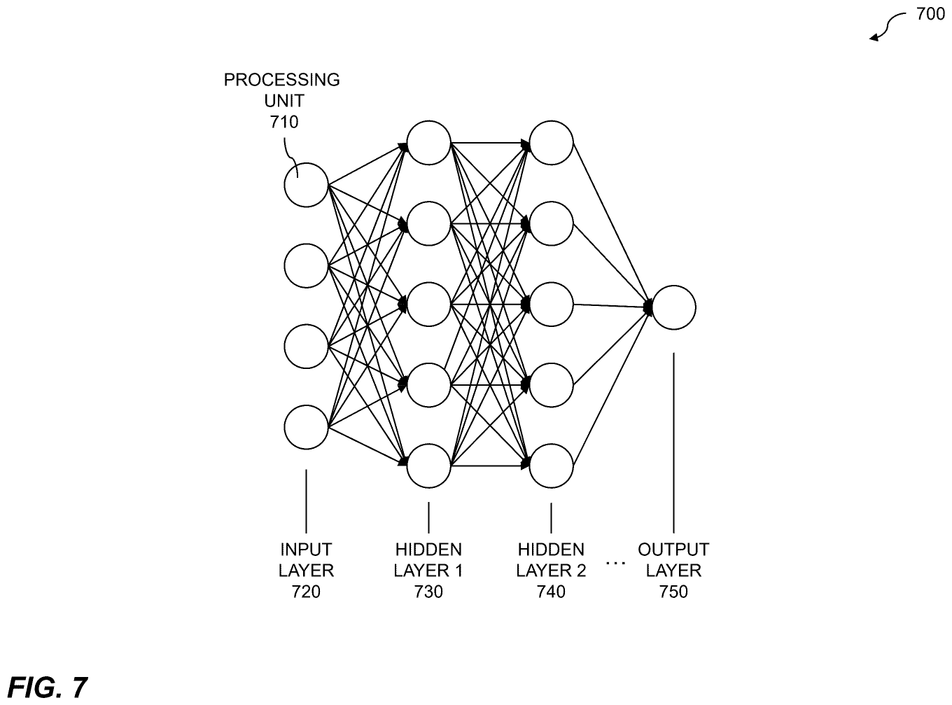

FIG. 7 is an example of a convolutional neural network. The acoustic sensor disclosed can include a machine learning (ML) model. The ML model can comprise any type of ML model including a large language model (LLM), small language model (SLM), neural network, convolutional neural network, and so on. The ML model can be implemented as a TinyML™ model.

The TinyML™ model can implement a CNN on a resource constrained device such as an embedded processor, acoustic embedded controller, and so on. A CNN can be a system of interconnected programming objects, called neurons, which can exchange messages among each other. The connections among the neurons can have numeric weights that can be altered during the training process so that the desired responses are received when new input is entered into the network. The network can comprise two or more layers of feature-detecting neurons. The layers can include an input layer, one or more hidden layers, and an output layer. Each layer can include many neurons that respond to different combinations of inputs from the previous layers.

The example 700 includes a processing unit 710. The processing unit can be a microprocessor, embedded processor, processor core, functional unit, software thread, program function, and so on. The processing unit can comprise a node. The example 700 includes an input layer 720 of convolutional neural network neurons. The input layer can be the starting point for processing data in a neural network. The input layer can receive data that represents acoustic data received from the hydrophones coupled to the acoustic sensor. The data can comprise one or more feature vectors. The feature vectors can be based on any number of aspects of the underwater audio signal received by the hydrophones. Examples of aspects of the underwater signal can include the length of a specific sound, noise levels, energy within frequency bands, signal energies within wavelet scales, statistics of the underwater audio signal, statistics of a transformed underwater audio signal, and so on. Many other aspects are possible. The acoustic underwater signal can be filtered for a specific frequency band before the aspects of the signal are selected. This can limit background noise or unwanted audio in the signal and can increase the ability of the machine learning model to make an accurate classification. Recall that the acoustic sensor can include an embedded acoustic controller. In embodiments, the embedded acoustic controller hosts a machine learning model. Recall also that a first DSP function can be performed on a first underwater signal that is received. In embodiments, the first DSP function includes classifying, by the machine learning model, an underwater signal source. The classifying can comprise an inference by the machine learning model.

The CNN input layer can receive the feature vectors or a transformed version of the feature vectors. Transforming the feature vectors can increase the accuracy of the machine learning model. The classifying can include transforming the one or more feature vectors. The transforming can be based on Mel-frequency cepstral coefficients (MFCCs). The MFCCs can be coefficients within a Mel-frequency cepstrum (MFC). The MFC can be a representation of the power spectrum of the underwater audio signal. The transforming can be based on a fast Fourier transform (FFT). An FFT can convert an analog signal, such as the underwater audio signal, to the frequency domain. In this way, the signal can be decomposed into one or more constituent frequencies. Each constituent frequency can be evaluated for magnitude (power). The transforming can be based on a wavelet transformation. A wavelet transformation can decompose a function into a set of wavelets, which can be frequency components within a signal, such as an underwater audio signal, localized in time. While an FFT can analyze an entire signal, a wavelet transformation can perform localized time-frequency analysis. Additional transformations of the feature vectors are possible before sending to the input layer of the CNN. The transforming can be accomplished by the acoustic embedded controller, or another device included in the acoustic sensor.

The CNN can use a filter at the beginning of processing to detect certain features in the audio input. The filter can be a matrix of numeric weights and/or biases applied to each value in the input layer. For example, the feature vectors can contain several distinct sounds at different frequency ranges, or bands. The filter process, called a convolution operation, can highlight the presence of distinct sounds based on their frequency and voltage ranges within the raw data and can process each sound group separately. Each distinct sound can be represented as a feature map of data that can be used as input for subsequent layers in the neural network.

The example 700 includes hidden layers of neurons within the convolutional neural network. Two hidden layers of neurons are shown, hidden layer 1 730 and hidden layer 2 740. The CNN can include any number of hidden layers, depending on the complexity of the audio signals input into the network. As can be seen in the example diagram, each hidden layer can function as an input layer for subsequent layers of neurons. The raw data input layer inputs data into hidden layer 1. Hidden layer 1 acts as input for hidden layer 2, and so on. Each layer can be more complex than the previous layer, combining features identified in earlier layers to recognize more complex patterns. During the training process, these complex patterns of audio data can be associated with specific sources, including marine mammals or fish, natural occurrences such as earthquakes, manmade activity such as fishing or drilling, and so on. As more training data is collected and entered into the CNN, the machine language model can improve with regard to identifying sources of audio data. The example 700 includes an output layer 750. The output layer can include an identification of a source of audio data received by the hydrophones and analyzed by the machine language model. As more sound data is collected, the source can be associated with animal behaviors such as feeding, breeding, hunting, and so on. The CNN can include an associated probability score with the classification output. The probability score can be high confidence, low confidence, inconclusive, and so on based on the processing of the CNN. Thus, embodiments include generating an associated probability score. In embodiments, the associated probability score predicts an accuracy of the classifying.

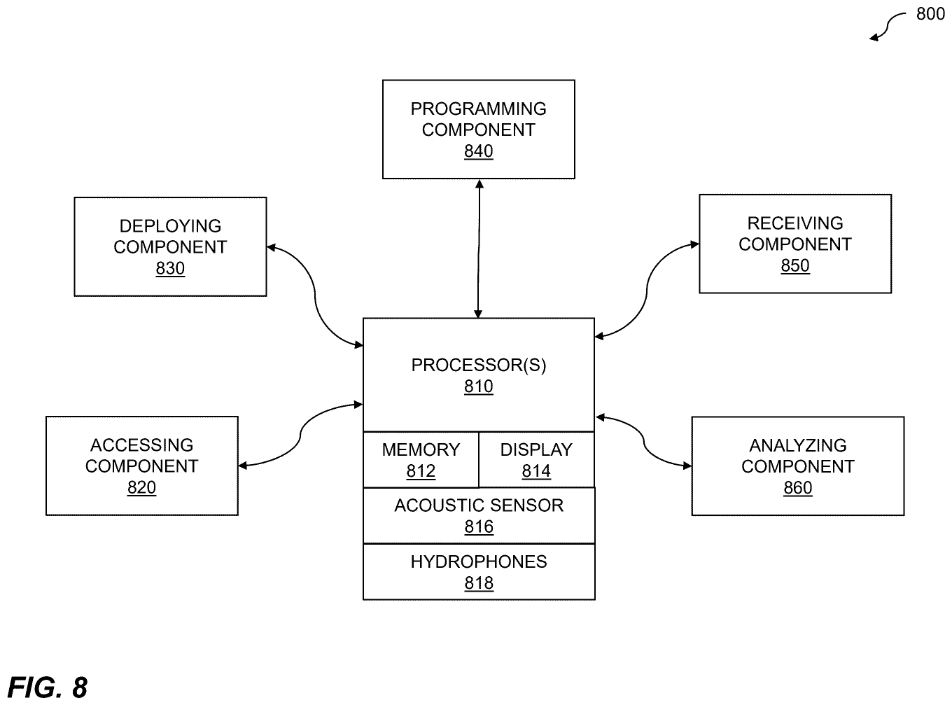

FIG. 8 is a system diagram for a software-defined hydrophone with acoustic sensor functions and machine learning. The system can include one or more of processors, memories, cache memories, displays, and so on. The system 800 can include one or more processors 810. The processors can include standalone processors within integrated circuits or chips, processor cores such as cores in FPGAs or ASICs, and so on. The one or more processors can include one or more processors within a system-on-a-chip (SoC). The one or more processors are coupled to a memory 812, which stores instructions. The memory can include one or more of local memory, cache memory, system memory, etc. The system 800 can further include a display 814 coupled to the one or more processors. The display can be used for displaying data, instructions, operations, program states, machine learning models, DSP functions, and the like. The system can include an acoustic sensor 816 in accordance with described embodiments. The system can include one or more hydrophones 818 which can be coupled to the acoustic sensor. In embodiments, one or more processors are coupled to the memory where the one or more processors, when executing the instructions which are stored, are configured to: access the acoustic sensor, wherein the acoustic sensor includes one or more acoustic channels, wherein the acoustic sensor is coupled to the one or more hydrophones, and wherein a first hydrophone within the one or more hydrophones is associated with a first acoustic channel within the one or more acoustic channels; program, via software, one or more digital signal processing (DSP) functions of the acoustic sensor, wherein a first DSP function is associated with a first frequency band and the first acoustic channel; receive, by the first hydrophone, a first underwater audio signal; and analyze, by the acoustic sensor, the first underwater audio signal, wherein the analyzing includes sampling the first underwater audio signal, and wherein the analyzing is based on the first DSP function associated with the first acoustic channel.

The system 800 can include a computer program product embodied in a non-transitory computer readable medium for manipulating acoustic data, the computer program product comprising code which causes one or more processors to perform operations of: accessing an acoustic sensor, wherein the acoustic sensor includes one or more acoustic channels, wherein the acoustic sensor is coupled to one or more hydrophones, and wherein a first hydrophone within the one or more hydrophones is associated with a first acoustic channel within the one or more acoustic channels, and wherein the acoustic sensor and the one or more hydrophones are deployed in a body of water; programming, via software, one or more digital signal processing (DSP) functions of the acoustic sensor, wherein a first DSP function is associated with a first frequency band and the first acoustic channel; receiving, by the first hydrophone, a first underwater audio signal; and analyzing, by the acoustic sensor, the first underwater audio signal, wherein the analyzing includes sampling the first underwater audio signal, and wherein the analyzing is based on the first DSP function associated with the first acoustic channel.

The system 800 includes an accessing component 820. The accessing component includes functions and instructions for accessing an acoustic sensor, wherein the acoustic sensor includes one or more acoustic channels, wherein the acoustic sensor is coupled to one or more hydrophones, and wherein a first hydrophone within the one or more hydrophones is associated with a first acoustic channel within the one or more acoustic channels. The acoustic sensor can include any number of embedded acoustic controllers, embedded processors, acoustic controllers, digital down converters, filters, processors, memory devices, storage devices, power supplies, batteries, and so on. The sensor can include capabilities for running machine learning (ML) models, such as a TinyML™ model. The machine learning models can comprise edge artificial intelligence (AI). The acoustic sensor includes one or more acoustic channels. One or more hydrophones can be coupled to a channel. Any number of acoustic channels can be supported. The channels can allow the sensor to receive signals for processing. The acoustic channels can be programmable via software such that each channel can be assigned a frequency, bandwidth, filter, digital signal processing (DSP) function, etc.

The system 800 includes a deploying component 830. The deploying component includes functions and instructions for deploying, in a body of water, the acoustic sensor and the one or more hydrophones. The acoustic sensor can be deployed in any body of water including fresh water, salt water, briny water, etc. The sensor can be deployed with a diver; from a surface vessel, a UUV, or a remotely operated underwater vehicle (ROUV); and so on. In embodiments, the acoustic sensor and the one or more hydrophones comprise a software-defined hydrophone (SDH).

The system 800 includes a programming component 840. The programming component includes functions and instructions for programming, via software, one or more digital signal processing (DSP) functions of the acoustic sensor, wherein a first DSP function is associated with a first frequency band and the first acoustic channel. The programming can be accomplished via software and can be performed at any time. The programming can use APIs which can provide access to the audio sensor. The programming can be accomplished remotely. In embodiments, the first DSP function includes classifying, by the machine learning model, an underwater signal source. In some embodiments, the first DSP function includes recording data. In other embodiments, the first DSP function includes tracking a fish tag. In some embodiments, the first DSP function includes detecting a vessel. In embodiments, the first DSP function includes monitoring an underwater object of interest. In embodiments, the first DSP function includes signal intelligence.

In embodiments, the programming includes a second DSP function, wherein the second DSP function is associated with a second frequency band and a second acoustic channel within the one or more acoustic channels, and wherein a second hydrophone within the one or more hydrophones is associated with the second acoustic channel. The first DSP function and the second DSP function can be evaluated in parallel by the acoustic sensor. The programming can include reprogramming the acoustic sensor. Any of the DSP and/or machine learning functions can be changed at any time. In embodiments, the reprogramming updates a resolution of the sampling the first underwater audio signal. In some embodiments, the reprogramming changes the first DSP function. In other embodiments, the reprogramming includes reassociating the first hydrophone with a second channel within the one or more acoustic channels.

The system 800 includes a receiving component 850. The receiving component includes functions and instructions for receiving, by the first hydrophone, a first underwater audio signal. The underwater audio signal can comprise a time series analog signal. The hydrophones can detect underwater audio signals produced by one or more audio sources. The one or more hydrophones can be used to record or monitor marine organisms, submarines, ships, and other underwater activities that generate sound. The hydrophones convert the sound waves into electrical signals and send them to the embedded acoustic controller for analysis by the machine learning model.

The system 800 includes an analyzing component 860. The analyzing component includes functions and instructions for analyzing, by the acoustic sensor, the first underwater audio signal, wherein the analyzing includes sampling the first underwater audio signal, and wherein the analyzing is based on the first DSP function associated with the first acoustic channel. The analyzing can produce results of the DSP function that was selected. For example, the acoustic sensor can classify an underwater audio sound, track the location of a fish tracker, record data, detect vessels, detect aquatic animals, monitor underwater objects or activity, and so on. In embodiments, the analyzing includes converting, by an embedded acoustic controller within the acoustic sensor, the first underwater audio signal to a first digital signal. In other embodiments, the embedded acoustic controller includes a digital down converter (DDC), wherein the DDC converts the first digital signal to a low frequency baseband signal.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for manipulating acoustic data comprising:
accessing an acoustic sensor, wherein the acoustic sensor includes one or more acoustic channels, wherein the acoustic sensor is coupled to one or more hydrophones, and wherein a first hydrophone within the one or more hydrophones is associated with a first acoustic channel within the one or more acoustic channels;
deploying, in a body of water, the acoustic sensor and the one or more hydrophones;
programming, via software, one or more digital signal processing (DSP) functions of the acoustic sensor, wherein a first DSP function is associated with a first frequency band and the first acoustic channel;
receiving, by the first hydrophone, a first underwater audio signal; and
analyzing, by the acoustic sensor, the first underwater audio signal, wherein the analyzing includes sampling the first underwater audio signal, and wherein the analyzing is based on the first DSP function associated with the first acoustic channel.

2. The method of claim 1 wherein the acoustic sensor and the one or more hydrophones comprise a software-defined hydrophone (SDH).

3. The method of claim 2 wherein the programming is accomplished remotely.

4. The method of claim 2 further comprising reprogramming the acoustic sensor.

5. The method of claim 4 wherein the reprogramming adjusts the first frequency band.

6. The method of claim 4 wherein the reprogramming updates a resolution of the sampling the first underwater audio signal.

7. The method of claim 4 wherein the reprogramming changes the first DSP function.

8. The method of claim 4 wherein the reprogramming includes reassociating the first hydrophone with a second channel within the one or more acoustic channels.

9. The method of claim 1 further comprising filtering, by the acoustic sensor, the first underwater audio signal, wherein the filtering is based on the first frequency band.

10. The method of claim 9 wherein the analyzing includes converting, by an embedded acoustic controller within the acoustic sensor, the first underwater audio signal to a first digital signal.

11. The method of claim 10 wherein the embedded acoustic controller includes a digital down converter (DDC), wherein the DDC converts the first digital signal to a low frequency baseband signal.

12. The method of claim 11 wherein the embedded acoustic controller hosts a machine learning model.

13. The method of claim 12 wherein the first DSP function includes classifying, by the machine learning model, an underwater signal source.

14. The method of claim 11 wherein the first DSP function includes recording data.

15. The method of claim 11 wherein the first DSP function includes tracking a fish tag.

16. The method of claim 11 wherein the first DSP function includes detecting a vessel.

17. The method of claim 11 wherein the first DSP function includes monitoring an underwater object of interest.

18. The method of claim 11 wherein the first DSP function includes signal intelligence.

19. The method of claim 1 wherein the programming includes a second DSP function, wherein the second DSP function is associated with a second frequency band and a second acoustic channel within the one or more acoustic channels, and wherein a second hydrophone within the one or more hydrophones is associated with the second acoustic channel.

20. The method of claim 19 wherein the receiving includes obtaining, by the second hydrophone, a second underwater audio signal.

21. The method of claim 20 further comprising filtering, by the acoustic sensor, the second underwater audio signal, wherein the filtering is based on the second frequency band.

22. The method of claim 21 further comprising evaluating, by the acoustic sensor, the second underwater audio signal, wherein the analyzing is based on the second DSP function associated with the second acoustic channel.

23. The method of claim 22 wherein the analyzing and the evaluating occur in parallel.

24. A computer program product embodied in a non-transitory computer readable medium for manipulating acoustic data, the computer program product comprising code which causes one or more processors to perform operations of:
accessing an acoustic sensor, wherein the acoustic sensor includes one or more acoustic channels, wherein the acoustic sensor is coupled to one or more hydrophones, wherein a first hydrophone within the one or more hydrophones is associated with a first acoustic channel within the one or more acoustic channels, and wherein the acoustic sensor and the one or more hydrophones are deployed in a body of water;
programming, via software, one or more digital signal processing (DSP) functions of the acoustic sensor, wherein a first DSP function is associated with a first frequency band and the first acoustic channel;
receiving, by the first hydrophone, a first underwater audio signal; and
analyzing, by the acoustic sensor, the first underwater audio signal, wherein the analyzing includes sampling the first underwater audio signal, and wherein the analyzing is based on the first DSP function associated with the first acoustic channel.

25. A computer system for manipulating acoustic data comprising:
a memory which stores instructions;
one or more hydrophones;
an acoustic sensor, wherein the one or more hydrophones and the acoustic sensor is deployed in a body of water; and
one or more processors coupled to the memory wherein the one or more processors, when executing the instructions which are stored, are configured to:
access the acoustic sensor, wherein the acoustic sensor includes one or more acoustic channels, wherein the acoustic sensor is coupled to the one or more hydrophones, and wherein a first hydrophone within the one or more hydrophones is associated with a first acoustic channel within the one or more acoustic channels;
program, via software, one or more digital signal processing (DSP) functions of the acoustic sensor, wherein a first DSP function is associated with a first frequency band and the first acoustic channel;
receive, by the first hydrophone, a first underwater audio signal; and
analyze, by the acoustic sensor, the first underwater audio signal, wherein the analyzing includes sampling the first underwater audio signal, and wherein the analyzing is based on the first DSP function associated with the first acoustic channel.
